(19) United States
(12) Patent Application Publication
(10) Pub. No.: US 2012/0155975 A1
(43) Pub. Date: Jun. 21, 2012

(54) METHOD AND APPARATUS IN CONNECTION WITH A REFUSE CHUTE

(76) Inventor: Göran Sundholm, Tuusula (FI)

(21) Appl. No.: 13/393,300

(22) PCT Filed: Aug. 17, 2010
(86) PCT No.: PCT/FI10/50645

§ 371 Date: Feb. 29, 2012

(30) Foreign Application Priority Data
Sep. 1, 2009 (FI) 20095897

(51) Int. Cl. B65G 53/58

(52) U.S. Cl. 406/84

(57) ABSTRACT

Method in connection with a refuse chute (1), which refuse chute comprises at least one input aperture (4) of the waste material, in which method the waste material (5) input into the refuse chute from an input aperture (4) is moved in the refuse chute under the effect of gravity to the bottom part of the refuse chute. An opposing air flow with respect to the direction of travel of the waste material (5) is brought about in the refuse chute (1), with which air flow the speed of movement of the waste material is influenced. The invention also relates to an apparatus.

### BACKGROUND OF THE INVENTION

The object of the invention is a method as defined in the preamble of claim 1.

The object of the invention is also an apparatus as defined in the preamble of claim 10.

The invention relates generally to materials moving systems, such as partial-vacuum conveying systems, more particularly to the collection and moving of wastes, such as to the moving of household wastes. The invention also relates to refuse chutes, with which waste is typically moved by gravity, e.g. from upper input apertures in residential apartments to a lower collection space or corresponding.

Systems wherein wastes are moved in piping by means of a pressure difference or suction are also known in the art. In these, wastes are moved long distances in the piping by sucking. It is typical to these systems that a partial-vacuum apparatus is used to bring about a pressure difference, in which apparatus a partial vacuum is achieved in the transfer pipe with partial-vacuum generators, such as with vacuum pumps or with an ejector apparatus. A transfer pipe typically comprises at least one valve means, by opening and closing which the replacement air coming into the transfer pipe is regulated. Refuse chutes are used in the systems at the material input end, into which refuse chutes material, such as waste material, is input and from which refuse chutes the material to be transferred is transferred into a transfer pipe by opening a discharge valve means, in which case, by means of the sucking effect achieved by the aid of the partial vacuum acting in the transfer pipe and also by means of the surrounding air pressure acting via the refuse chute, material such as e.g. waste material packed into bags, is transferred from the refuse chute into the transfer pipe. The pneumatic waste transfer systems in question can be utilized particularly well in densely populated urban areas. These types of areas have tall buildings, in which the input of wastes into a pneumatic waste transfer system is performed via a refuse chute arranged in the building.

The refuse chute is a vertical pipe comprising a number of input points, which are typically arranged in the wall of the refuse chute at a distance from each other. Tall buildings can comprise many tens, even hundreds, of storeys, in which case the refuse chute forms a very high pipe. In this case waste, e.g. in bags, to be input into the refuse chute from above falls a long distance in the chute, e.g. up to 200 m, in which case the speed of the waste material accelerates to be very high as it falls downwards in the refuse chute. Freely falling waste material is smashed in the bottom end of the refuse chute. One problem can be that the waste that has fallen at a high speed into the bottom part of the refuse chute and smashed, and which waste is tightly compacted in the bottom part of the chute, does not always move into the transfer piping from the bottom part of the refuse chute. When the waste material has become compacted onto the bottom of the refuse chute, near the output aperture, one problem is that the material that has compacted in the proximity of the output aperture might block the output aperture, in which case transfer of the material from the refuse chute into the transfer pipe is prevented and/or the access of replacement air from the refuse chute into the transfer pipe is prevented. Attempts have been made to prevent compacting of the waste material by arranging mechanical obstacles in the chute, by means of which it is endeavored to slow down the falling speed of waste bags in the refuse chute. A problem with mechanical deceleration obstacles is that the waste bags often break when they hit them, in which case the wastes make the inside surface of the refuse chute unnecessarily dirty. This makes keeping the refuse chute clean more difficult and, in addition, the wastes from broken waste bags that have made the refuse chute dirty create odor nuisances. In addition, the collision of waste material with an obstacle creates noise nuisances.

The aim of the present invention is to achieve a new type of solution in connection with refuse chutes, by means of which the drawbacks of prior art will be avoided.

### BRIEF DESCRIPTION OF THE INVENTION

The invention is based on a concept wherein means for producing an air flow in a refuse chute against the direction of movement of the waste material are arranged in connection with the refuse chute, by means of which air flow the movement of waste material in the refuse chute can, among other things, be slowed down.

The method according to the invention is mainly characterized in that an opposing air flow with respect to the direction of travel of the waste material is brought about in the refuse chute, with which air flow the speed of movement of the waste material is influenced.

The method according to the invention is also characterized by what is stated in claims 2-9.

The apparatus according to the invention is mainly characterized in that the apparatus comprises means for bringing about an opposing air flow with respect to the direction of travel of the waste in the refuse chute, which apparatus is fitted to influence the speed of movement of the waste material in the refuse chute.

The apparatus according to the invention is also characterized by what is stated in claims 11-18.

The solution according to the invention has a number of significant advantages. By means of the invention fast and effective emptying of the refuse chute into the transfer pipe is achieved. With the method and apparatus according to the invention it is possible to slow down in a controlled manner the falling speed of waste material in the refuse chute. At the same time it is possible to reduce the susceptibility to clogging of the output aperture of the refuse chute, in which case the operation of the pneumatic materials moving system remains good. Another significant advantage is the leading of the particles and odors of the refuse chute out of the refuse chute along with the air flow, in which case inconvenience due to odors can be substantially reduced. According to the invention material refuse chutes, which are the disposal points of waste, can be used, such as waste receptacles or refuse chutes. The method and apparatus according to the invention are particularly well suited in connection with transfer systems of waste material, such as waste material arranged in bags. The pump device always produces a small air flow in the non-active state in normal operation, with which air flow the development of odors, gases and also small particles in the chute are prevented, in which case the fire hazard and explosion hazard are reduced. The air flow brought about by the pump device is boosted when the hatch of the input aperture is opened or waste bags are otherwise allowed into the chute. A delay of the desired length can be used in connection with boosting the air flow and opening/closing the hatch.

A material space, i.e. an input pocket, can be in connection with the input apertures, the emptying of which material space is typically performed from the bottom upwards so that the initiation of clogging in the chute is prevented. The air flow can also be arranged such that at first the air flow lifts the waste material upwards in the refuse chute and after that the air flow is regulated, e.g. by reducing the amount of air in a controlled manner such that the waste material descends at the desired speed downwards to the material space. This arrangement is preferably achieved with an air ejector, wherein air is taken from the accumulator, the pressure of which decreases during the emptying cycle. One advantage of an air ejector is also that air is added to the exhaust, in which case there are fewer microparticles per unit.

### BRIEF DESCRIPTION OF THE FIGURES

In the following, the invention will be described in more detail by the aid of an embodiment with reference to the attached drawings, wherein

FIG. 1 presents one simplified embodiment of an apparatus according to the invention, in a first operating mode,

FIG. 2 presents one simplified embodiment of an apparatus according to the invention, in a second operating mode,

FIG. 3 presents a second embodiment of an apparatus according to the invention, in a first operating mode,

FIG. 4 presents a second embodiment of an apparatus according to the invention, in a second operating mode,

FIG. 5 presents a third embodiment of an apparatus according to the invention, in a first operating mode,

FIG. 6 presents a third embodiment of an apparatus according to the invention, in a second operating mode,

FIG. 7 presents a fourth embodiment of an apparatus according to the invention, in a first operating mode,

FIG. 8 presents a fourth embodiment of an apparatus according to the invention, in a second operating mode,

FIG. 9 presents a detail of an apparatus according to the invention, in a first position, and

FIG. 10 presents a detail of an apparatus according to the invention, in a second position.

### DETAILED DESCRIPTION OF THE INVENTION

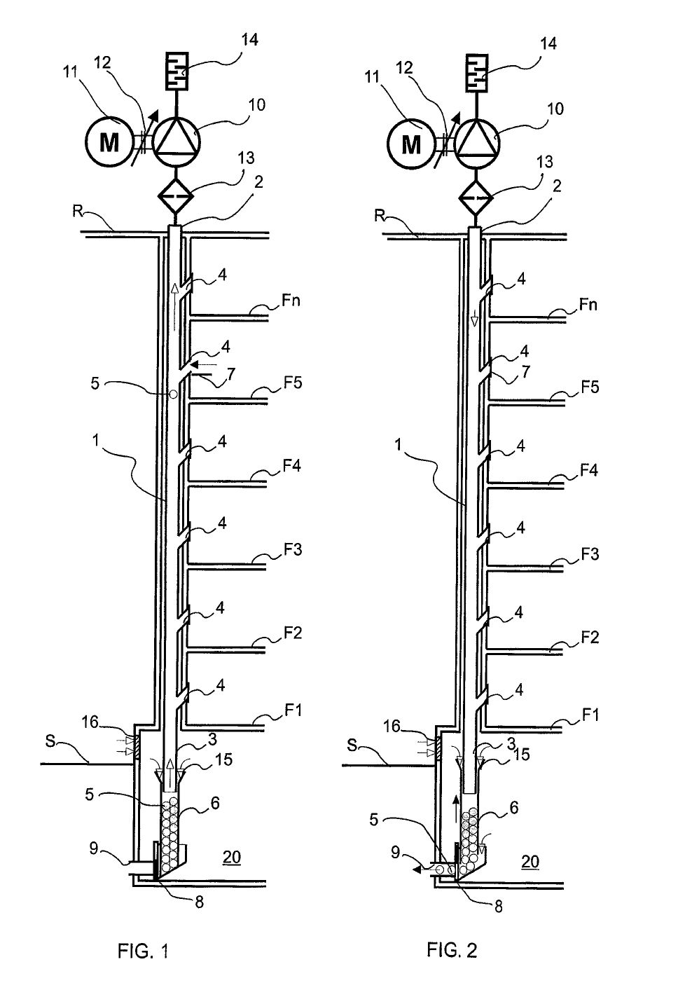

FIGS. 1 and 2 present one simplified and sectioned embodiment of the solution according to the invention. The refuse chute 1 of the materials moving system is in the figures. The refuse chute 1 extends in the vertical direction through the floors F1 . . . Fn of the building, in which case the top end 2 of the refuse chute extends e.g. to the roof R of the building. The bottom end 3 of the refuse chute 1 extends to the space 20 in the bottom part of the building, e.g. in the basement. In the figure the surface of the ground is marked with the letter S. One or more input apertures 4 are arranged in the refuse chute 1. The refuse chute 1 in the figure is a section of pipe that is arranged in a suitable location in the building.

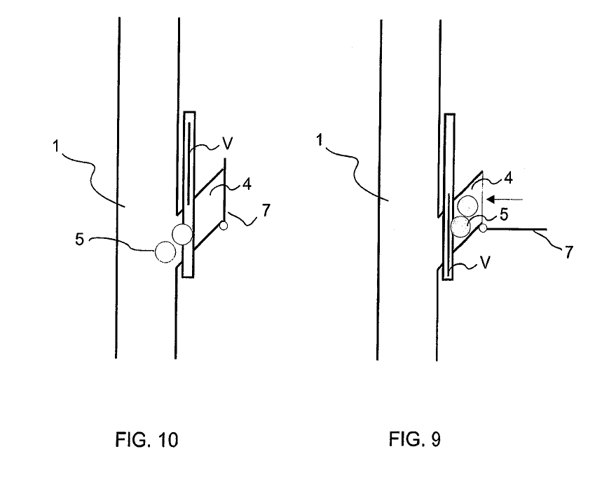

Material is input into the refuse chute via one or more input apertures 4. A hatch arrangement 7 or such kind can be in connection with the input aperture 4. Additionally, a valve means V, with which access of material into the refuse chute 1 is regulated, can be in connection with the input aperture. The hatch arrangement and valve arrangement according to one embodiment, which arrangement is in connection with the input aperture, is described in more detail below and in FIGS. 9 and 10. Typically waste material 5 is dropped from the input aperture 4 into the refuse chute 1. A number of input apertures 4 are arranged in the refuse chute, typically at least one for each floor F1 . . . Fn. The building in the embodiment of the figure comprises six floors, of which the topmost floor is marked in the figure with the marking Fn, in which case any number of floors whatsoever can be in question.

The refuse chute 1 is connected from its bottom part 3 to a transfer pipe 9. A discharge valve 8, which is used with a drive device (not shown), is between the transfer pipe 9 and the refuse chute 3. In the embodiment of FIG. 1, the bottom part 3 of the refuse chute comprises a material space 6, which is bounded by walls, into which material space the waste material 5, such as waste packed into bags, falls, typically under the effect of gravity.

The material 5 that is input from the input aperture 4 into the refuse chute 1 tries to compact under the effect of gravity into the bottom part 3 of the refuse chute 1, against the walls of the material space 6 of the bottom part and the discharge valve 8 of the output aperture. In a conventional arrangement there is a risk of clogging of the output aperture of the refuse chute and in pneumatic systems a risk of prevention of the access of replacement air that is essential from the viewpoint of operation in the discharge phase of the container.

To avoid the drawbacks of prior art the means 10, 11, 12 in the embodiment of FIGS. 1 and 2 are arranged in connection with the refuse chute, for slowing down the falling speed of the waste material 5 in the refuse chute 1 by means of an air flow. The apparatuses include a pump device 10, the suction side of which is connected to the top end 2 of the refuse chute. The pump device 10 is used with a drive means 11. A regulating apparatus 12, e.g. for regulating the speed of rotation of the pump, can be between the drive means and the pump device. With the apparatuses an air flow is produced in the refuse chute 1 in the opposite direction with respect to the falling direction of the waste material 5. In the embodiment of FIGS. 1 and 2, there is a filtering means 13 between the pump 10 and the refuse chute 1 and a noise muffler 14 on the blowing side of the pump.

When the waste material 5 is input into the refuse chute, an air flow is produced with the pump means 10 in the refuse chute 1 in the opposite direction with respect to the direction of movement of the waste material, which air flow is presented in FIG. 1 with arrows pointing upwards in the refuse chute 1, i.e. towards the first end 3 of the refuse chute. In order to produce the air flow, replacement air is needed in the refuse chute, which replacement air is received in FIGS. 1 and 2 from the replacement air aperture 15 formed in the refuse chute 1, preferably in the bottom part 3 of it, which aperture in the embodiment of the figure opens into the space 20. Correspondingly, the space 20 comprises an inlet air valve 16 or corresponding, via which the replacement air needed flows into the space 20. In the case of FIG. 1 the air flow acts in the refuse chute against the falling direction of an object, more particularly of waste material, such that the falling speed of the waste material 5, more particularly of the waste material packed in a bag, remains most suitably such that the waste material does not compact into the bottom part of the refuse chute too densely and, on the other hand, such that the waste bags remain intact from the fall and do not disintegrate.

In FIG. 1 the movement of the replacement air is presented with arrows from the air channel 16, from the replacement air channel 15 between the bottom part 3 of the refuse chute and the conical end of the top part of the material space 6 and onwards in the refuse chute from the effect of the suction produced by the pump 10 against the falling direction of the waste material.

In FIG. 1 waste material 5 is input into the refuse chute from one input aperture 4, in the figure that of the fifth floor F5, of the refuse chute 1 by opening the hatch 7. The waste material 5 drops towards the bottom end 3 of the chute under the effect of gravity. The pump device 10 produces an opposing air flow, slowing down the falling of the waste material in the refuse chute 1. The pump device 10 can be e.g. an extractor, which sucks air upwards at such a speed that it slows down the downward-falling waste material, such as a waste bag.

The pump device 10 is preferably arranged to operate at a number of speeds such that in the normal mode there is low suction, which removes odor from the chute and from the waste room 20. When the hatch 7 of the input aperture 4 of a certain floor F1 . . . Fn is opened, the suction produced by the pump device 10 is fitted to the preprogrammed level required by the floor in question, which level essentially prevents the movement of the bag from accelerating downwards.

FIG. 2 presents, for its part, the apparatus according to the embodiment of FIG. 1 in a second operating mode, in which the waste material that has collected in the material space 6 in the bottom part of the refuse chute 1 is moved to a transfer pipe 9 of a pneumatic waste transfer system, in a manner that is in itself prior art, by opening the valve 8, in which case the material is able to move into the transfer pipe 9 from the effect of the pressure difference.

In the embodiment according to the figures it is also possible to move the pipe-like wall of the material space 6 between two positions, a first position in which the wall of the material space 6 is in a bottom position, in which case the waste material in the material space is not able to press against the valve 8, and a second position, in which there is an aperture between the wall of the material space 6 and the base of the material space, from which aperture the material is able to move towards the transfer pipe 9 and the valve means. This is an additional feature, which is not necessary in the application of the invention.

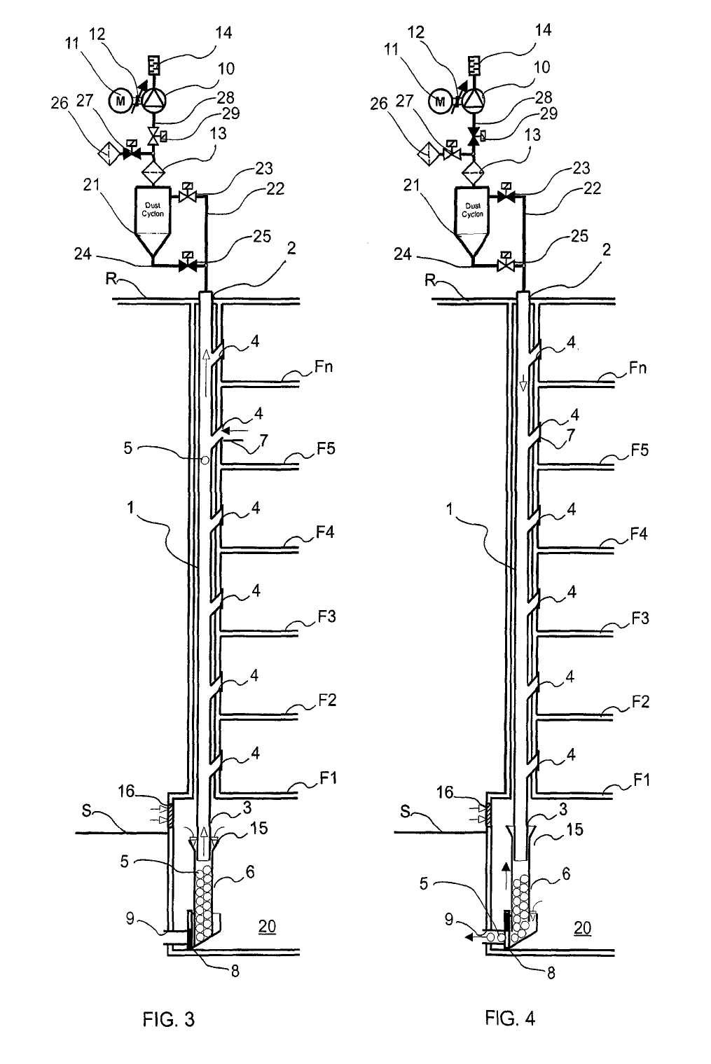

FIGS. 3 and 4 present a second embodiment of the invention, in which a separator device 21, more particularly a particle separator, is arranged between the top end 2 of the refuse chute and the pump means 10. FIG. 3 describes an operating mode, in which there is a corresponding situation to that in FIG. 1, in which case the movement of the waste material 5 in the refuse chute, which material is input into the refuse chute, is influenced with the air flow brought about by the pump device 10. At the same time the particles that travel along with the air flow travel along the path of passage 22 of the medium, more particularly a pipeline, from the refuse chute 1 into the separating device 21, in which at least a part of the particles that travel along with the air flow separate from the air flow. The separating device 21 is typically a cyclone separator, wherein the heavier particles separate from the air flow by means of centrifugal force and collect on the base of the separator.

FIG. 4 presents the apparatus of FIG. 3 in a second operating mode, i.e. in the emptying mode. In the figure, waste material that has collected in the bottom part of the refuse chute is emptied into the transfer pipe in a corresponding manner to the solution presented in FIGS. 1 and 2. In addition to what is presented in these figures, the particles that have collected in the separating device 21 are simultaneously emptied by closing the pipeline 22 that runs to the top part of the separating device from the top part of the refuse chute with a valve 23. At the same time the path of passage 28 of the medium leading from the separating device to the suction side of the pump 10 is closed by closing the valve 29 in it. Correspondingly, the path of passage 24 of the medium passing from the bottom part of the separating device to the top part of the refuse chute is opened by opening the valve means 25 in said path of passage. The valve 27 of the replacement air line is also opened, which valve is between the separating device 21 and the valve 29 that closes the path of passage 28 of the medium leading to the suction side of the pump 10. In this case the suction and the pressure difference acting in the transfer pipe 9 and in the bottom part of the refuse chute cause the transfer of the particles of the separating device from the separating device along the path of passage 24 of the medium into the refuse chute and onwards to the bottom part of the refuse chute and onwards from there into the transfer pipe 9.

With the separating device it is therefore possible to prevent larger particles from getting into the filter 13. The service life of the filter 13 is thereby lengthened and at the same time any odor nuisances, among other things, caused by particles are reduced. On the other hand, particles are prevented from getting into the outside air.

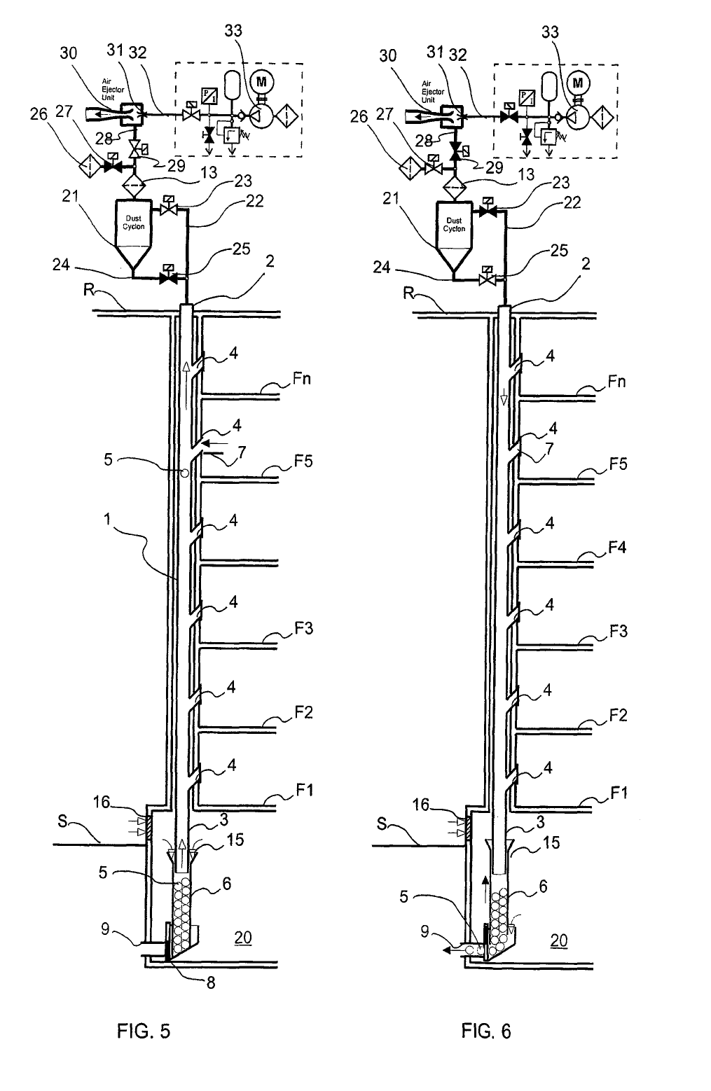

In the embodiments of FIGS. 5 and 6 the pump device is an ejector pump, in which suction is produced in a medium channel 28 connected to the suction side of the pump device by spraying medium into an ejector pipe 30 under pressure with a medium nozzle 31, which medium channel is according to the figure connected to the separating device 21 and further by the medium channel 22 to the top part 2 of the refuse chute 1. Medium is brought to the ejector nozzle under pressure with a pressure developer 33, such as with a compressor that produces compressed air, via the path of passage 32 of the medium. The air flow in the refuse chute can be regulated with the ejector pump, in which case the falling speed of the material 5 in the refuse chute, which material is input via an input aperture 4 into the refuse chute 1, can be regulated.

FIG. 6 presents an operating mode, in which the refuse chute 1 is emptied. At the same time the particles that have collected in the separating device 21 are also led into the outlet pipe 9 via the refuse chute. In this case pressure medium is not led to the nozzle 31, but instead the valve of the path of passage 32 of the medium between the pressure developer 33 and the nozzle 31 is closed. The valve 29 of the path of passage 28 the medium between the separating means and the pump device is closed and also the connection between the top part of the separating device 21 and the top part 2 of the refuse chute 1 by closing the valve 23 of the path of passage 22 of the medium. Correspondingly, the path of passage 24 of the medium passing from the bottom part of the separating device 21 to the top part 2 of the refuse chute 1 is opened by opening the valve means 25 in said path of passage. The valve 27 of the replacement air line is also opened, which valve is between the separating device 21 and the valve 29 that closes the path of passage 28 of the medium leading to the suction side of the pump. In this case the suction and the pressure difference acting in the transfer pipe 9 and in the bottom part of the refuse chute cause the transfer of the particles of the separating device from the separating device along the path of passage 24 of the medium into the refuse chute and onwards to the bottom part of the refuse chute and onwards from there into the transfer pipe 9.

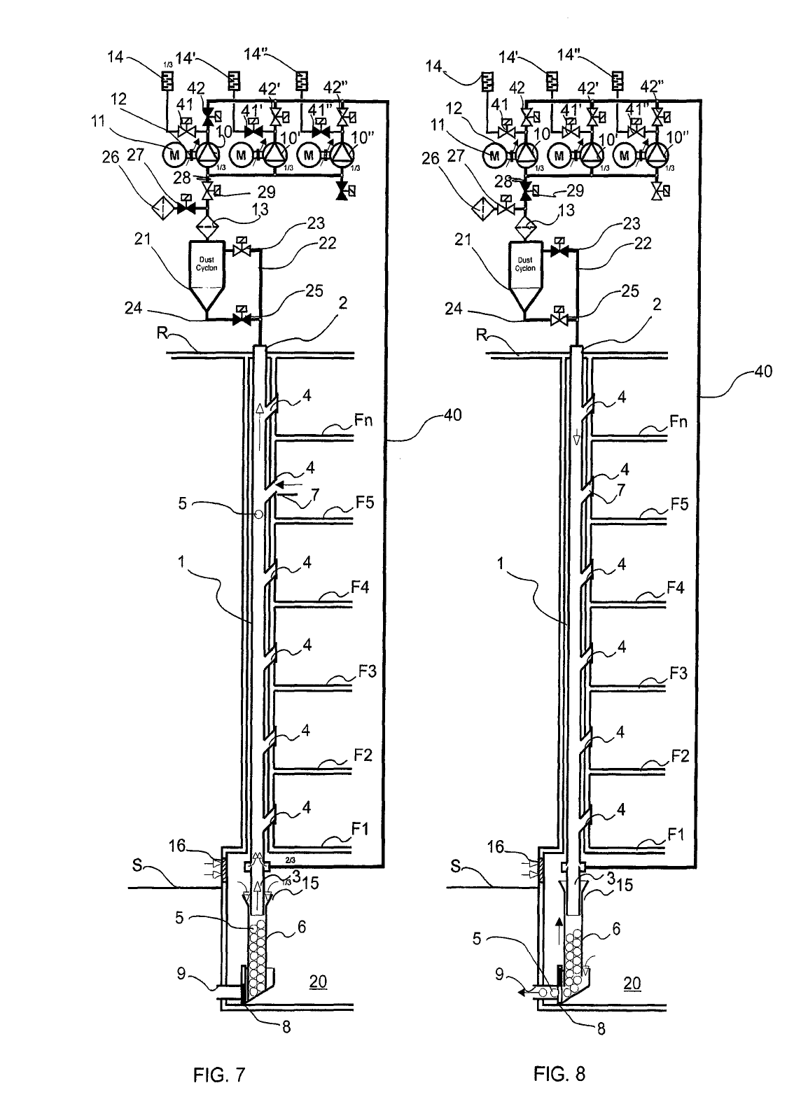

FIGS. 7 and 8 present yet another embodiment of the apparatus according to the invention. It differs from the preceding embodiments in that at least a part of the air flow can be circulated, by leading the path of passage 40 of the medium from the blowing side of the pump device back into the refuse chute 1, most suitably into the bottom part 3 of it. In this case the amount of air to be blown out can be reduced. The solution according to FIGS. 7 and 8 comprises a number of pump means 10, 10′, 10″, the suction sides of which can be connected to the separating device 21 and onwards to the top part of the refuse chute 1. The embodiment of the figures comprises three pump devices 10, 10′, 10″, which are connected in parallel. Each of the pump devices 10, 10′, 10″ can be individually connected in the embodiment of the figure to blow into the return channel, i.e. into the path of passage 40 of the medium, which path of passage leads the blast air back into the refuse chute 1, typically to the bottom part 3 of it. In the embodiment of FIG. 7 the blast air of the first pump device 10 is led out when the valve 41 is open via the channel provided with a noise muffler 14. The second pump device 10′ and the third pump device 10″ are fitted to circulate blast air into the medium channel 40, when the valves 41′ and 41″ are open. In this operating mode according to FIG. 7 an air flow is achieved in the refuse chute 1, against the falling direction of the waste material 5, in which case the falling of the material to the bottom of the chute into the material space 6 is slowed down.

In the embodiment of FIG. 7 each pump device 10, 10′, 10″ corresponds to an approx. ⅓ proportion of the suction produced. A ⅔ proportion of this is in the return circuit guided, via the path of passage 40 the medium, back to the refuse chute, to the bottom part of it, and ⅓ is led out of the system. The proportion of replacement air is thus ⅓ in the embodiment of the figure. The amount of air to be circulated and the ratio of the air to be blown out to the air to be circulated can be varied by regulating the rotational speeds of the pump devices and/or by opening or closing the valves 41, 41′, 41″ and/or 42, 42′, 42″, which lead the air on the blowing side of the pump devices either out of circulation or into the return circulation.

FIG. 8, for its part, presents a situation in which the waste material that has collected in the material space 6 of the bottom part 3 of the refuse chute 1 is emptied into the pipe 9. In the figure, the waste material that has collected in the bottom part of the refuse chute is emptied into the transfer pipe in a corresponding manner to the solution presented in FIGS. 1 and 2. In addition to what is presented in these figures, the particles that have collected in the separating device 21 are simultaneously emptied by closing the pipeline 22 that runs to the top part of the separating device from the top part of the refuse chute with a valve 23. At the same time the path of passage 28 of the medium leading from the separating device to the suction side of the pumps 10, 10′, 10″ is closed by closing the valve 29 in said path of passage. Correspondingly, the path of passage 24 of the medium passing from the bottom part of the separating device to the top part 2 of the refuse chute 1 is opened by opening the valve means 25 in said path of passage. In addition, the valve 27 of the replacement air line is also opened, which valve is between the separating device 21 and the valve 29 that closes the path of passage 28 of the medium leading to the suction side of the pumps 10, 10′, 10″. Additionally, in the embodiment of the figure the valves 41, 41′, 41″, 42, 42′, 42″, of the blowing side of the pumps have been opened, in which case it is possible to receive replacement air also via the path of passage 40 of the medium, i.e. via the return pipe

The suction and the pressure difference acting in the transfer pipe 9 and in the bottom part 3 of the refuse chute 1 cause the transfer of the particles of the separating device 21 from the separating device along the path of passage 24 of the medium into the top part 2 of the refuse chute and onwards to the bottom part 3 of the refuse chute and onwards from there into the transfer pipe 9.

According to certain preferred embodiments:
The pump device always produces a small air flow in the non-active state in normal operation, with which air flow the development of odors, gases and small particles in the chute are prevented. Fire hazard and explosion hazard.
The air flow brought about by the pump device is boosted when the hatch of the input aperture is opened or waste bags are otherwise allowed into the chute. A delay of the desired length can be used in connection with boosting the air flow and opening/closing the hatch.
A material space, i.e. an input pocket, can be in connection with the input apertures, the emptying of which space is typically performed from the bottom upwards so that the initiation of clogging in the chute is prevented.
The air flow can also be arranged such that at first the air flow lifts the waste material upwards in the refuse chute and after that the air flow is regulated, e.g. by reducing the amount of air in a controlled manner, such that the waste material descends at the desired speed downwards to the material space 6. This arrangement is preferably achieved with an air ejector, wherein air is taken from the accumulator, the pressure of which decreases during the emptying cycle.
One advantage of an air ejector is also that air is added to the exhaust, in which case there are fewer microparticles per unit.

The invention thus relates to a method in connection with a refuse chute 1, which refuse chute comprises at least one input aperture 4 of waste material, in which method the waste material 5 input into the refuse chute from an input aperture 4 is moved in the refuse chute under the effect of gravity to the bottom part of the refuse chute. An opposing air flow with respect to the direction of travel of the waste material 5 is brought about in the refuse chute 1, with which air flow the speed of movement of the waste material is influenced.

According to one preferred embodiment an air flow is brought about with at least one pump device 10, 10′, 10″, 30, such as with a fan or extractor.

According to one preferred embodiment the suction side of the pump device 10, 10′, 10″, 30 is connected to the top end of the refuse chute 1.

According to one preferred embodiment replacement air is brought into the refuse chute 1 from the opposite end with respect to the pump device 10, 10′, 10″, 30.

According to one preferred embodiment the properties of the air flow acting in the refuse chute 1 are regulated on the basis of at least one of the following parameters: the distance of the input point of the waste material 5 to the bottom part 3 of the refuse chute, the status of the shut-off valve V and/or of the input hatch 7 of the input aperture 4, the position of the input material in relation to the material space.

According to one preferred embodiment, in the method the input of the material 5 into the refuse chute 1 is regulated.

According to one preferred embodiment in the method at least a part of the air flow is recycled back into the refuse chute 1, preferably into the bottom part 3 of the refuse chute 1, from the blowing side of the pump device 10, 10′, 10″.

According to one preferred embodiment the air flow is led from the refuse chute 1 into a separating device 21, which is arranged in the path of flow of the medium between the top part of the refuse chute and the pump device.

According to one preferred embodiment, when emptying the material space 6 and/or the separating device 21 of the refuse chute 1, the air flow in the chute is changed to travel in the direction of travel of the material 5.

The invention also relates to an apparatus in connection with a refuse chute 1, which refuse chute comprises at least one input aperture 4 of the waste material, from which input aperture 4 the waste material 5 input into the refuse chute is fitted to move in the refuse chute under the effect of gravity to the bottom part of the refuse chute. The apparatus comprises means 10, 10′, 10″, 30 for bringing about an opposing air flow in the refuse chute 1 with respect to the direction of travel of the waste material 5, which apparatus is fitted to influence the speed of movement of the waste material in the refuse chute 1.

According to one preferred embodiment the means for bringing about an opposing air flow with respect to the direction of travel of the waste material comprise at least one pump device 10, 10′, 10″, 30, such as a fan or extractor.

According to one preferred embodiment the suction side of the pump device 10, 10′, 10″, 30 is connected to the top end of the refuse chute 1.

According to one preferred embodiment the apparatus comprises means 15 for bringing replacement air into the refuse chute 1 from the opposite end with respect to the pump device 10, 10′, 10″, 30.

According to one preferred embodiment the apparatus comprises means for regulating the properties of the air flow acting in the refuse chute 1 on the basis of at least one of the following parameters: the distance of the input point of the waste material 5 to the bottom part 3 of the refuse chute, the status of the shut-off valve V and/or of the input hatch 7 of the input aperture 4, the position of the input material 5 in relation to the material space 6.

According to one preferred embodiment the apparatus comprises means 7, V for regulating the input of material into the refuse chute.

According to one preferred embodiment the apparatus comprises means 40 for recycling at least a part of the airflow at least from the blowing side of the pump device 10, 10′, 10″ back into the refuse chute 1, preferably into the bottom part 3 of the refuse chute.

According to one preferred embodiment the apparatus further comprises a separating device 21, which is arranged in the path of flow of the medium between the top part 2 of the refuse chute and the pump device 10, 10′, 10″, 30.

According to one preferred embodiment, the apparatus is fitted to change the direction of travel of the air flow at least when emptying the material space and/or the separating device 21 of the refuse chute 1.

Typically the material 5 is waste material, such as waste material arranged in bags. The refuse chute can be fitted to be a part of a pneumatic waste transfer system or it can be a separate part, in which waste material is led into the waste room, waste container or corresponding.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Method in connection with a refuse chute (1), which refuse chute comprises at least one input aperture (4) of the waste material, in which method the waste material (5) input into the refuse chute from an input aperture (4) is moved in the refuse chute under the effect of gravity to the bottom part of the refuse chute, characterized in that an opposing air flow with respect to the direction of travel of the waste material (5) is brought about in the refuse chute (1), with which air flow the speed of movement of the waste material is influenced.

2. Method according to claim 1, characterized in that an air flow is brought about with at least one pump device (10, 10′, 10″, 30), such as with a fan or extractor.

3. Method according to claim 1, characterized in that the suction side of the pump device (10, 10′, 10″, 30) is connected to the top end of the refuse chute (1).

4. Method according to claim 1, characterized in that replacement air is brought into the refuse chute (1) from the opposite end with respect to the pump device (10, 10′, 10″, 30).

5. Method according to claim 1, characterized in that the properties of the air flow acting in the refuse chute (1) are regulated on the basis of at least one of the following parameters: the distance of the input point of the waste material (5) to the bottom part (3) of the refuse chute, the status of the shut-off valve (V) and/or of the input hatch (7) of the input aperture (4), the position of the input material in relation to the material space.

6. Method according to claim 1, characterized in that in the method the input of the material (5) into the refuse chute (1) is regulated.

7. Method according to claim 1, characterized in that in the method at least a part of the air flow is recycled back into the refuse chute, preferably into the bottom part of the refuse chute, from the blowing side of the pump device.

8. Method according to claim 1, characterized in that the air flow is led from the refuse chute into the separating device, which is arranged in the path of flow of the medium between the top part of the refuse chute and the pump device.

9. Method according to claim 1, characterized in that when emptying the material space (6) and/or the separating device (21) of the refuse chute (1) the air flow in the chute is changed to travel in the direction of travel of the material (5).

10. Apparatus in connection with a refuse chute (1), which refuse chute comprises at least one input aperture (4) of the waste material, from which input aperture (4) the waste material (5) input into the refuse chute is fitted to move in the refuse chute under the effect of gravity to the bottom part of the refuse chute, characterized in that the apparatus comprises means (10, 10′, 10″, 30) for bringing about an opposing air flow in the refuse chute (1) with respect to the direction of travel of the waste material (5), which apparatus is fitted to influence the speed of movement of the waste material in the refuse chute (1).

11. Apparatus according to claim 10, characterized in that the means for bringing about an opposing air flow with respect to the direction of travel of the waste material comprise at least one pump device (10, 10′, 10″, 30), such as a fan or extractor.

12. Apparatus according to claim 10, characterized in that the suction side of the pump device (10, 10′, 10″, 30) is connected to the top end of the refuse chute (1).

13. Apparatus according to claim 10, characterized in that the apparatus comprises means (15) for bringing replacement air into the refuse chute (1) from the opposite end with respect to the pump device (10, 10′, 10″, 30).

14. Apparatus according to claim 10, characterized in that the apparatus comprises means for regulating the properties of the air flow acting in the refuse chute (1) on the basis of at least one of the following parameters: the distance of the input point of the waste material (5) to the bottom part (3) of the refuse chute, the status of the shut-off valve (V) and/or of the input hatch (7) of the input aperture (4), the position of the input material (5) in relation to the material space (6).

15. Apparatus according to claim 10, characterized in that the apparatus comprises means (7, V) for regulating the input of the material into the refuse chute.

16. Apparatus according to claim 10, characterized in that the apparatus comprises means (40) for recycling at least a part of the airflow at least from the blowing side of the pump device (10, 10′, 10″) back into the refuse chute (1), preferably into the bottom part (3) of the refuse chute.

17. Apparatus according to claim 10, characterized in that the apparatus further comprises a separating device (21), which is arranged in the path of flow of the medium between the top part (2) of the refuse chute and the pump device (10, 10′, 10″, 30).

18. Apparatus according to claim 10, characterized in that the apparatus is fitted to change the direction of travel of the air flow at least when emptying the material space and/or the separating device (21) of the refuse chute (1).

19. Method according to claim 2, characterized in that the suction side of the pump device (10, 10′, 10″, 30) is connected to the top end of the refuse chute (1).

20. Method according to claim 2, characterized in that replacement air is brought into the refuse chute (1) from the opposite end with respect to the pump device (10, 10′, 10″, 30).
